(19) United States
(12) Patent Application Publication
(10) Pub. No.: US 2019/0198002 A1
(43) Pub. Date: Jun. 27, 2019

(54) CAPTIVE WIND CHIME

(71) Applicant: Michael Harry Brown, Rogersville, PA (US)

(72) Inventor: Michael Harry Brown, Rogersville, PA (US)

(21) Appl. No.: 16/530,389

(22) Filed: Nov. 2, 2016

(51) Int. Cl. G10K 1/076; G10D 13/08

(52) U.S. Cl. CPC G10K 1/076; G10D 13/08

(57) ABSTRACT

While traditional wind chimes typically produce pleasing sounds, the notes are random and at the mercy of which way the wind blows. The Captive Wind Chime overcomes this by keeping the chimes stationary and instead using a striker attached to a spinning rod to play notes in order. With the addition of one or more other “layers” of chimes and strikers, it can also produce polyphonic chords. Because of the pivoting blades and clutch the speed of the notes are partially regulated, allowing in its simplest form the rendition of traditional public domain melodies such as “God Bless America” or “How Great Thou Art”. In its most complex form it can produce synchronized polyphonic chord shape in whatever scale desired.

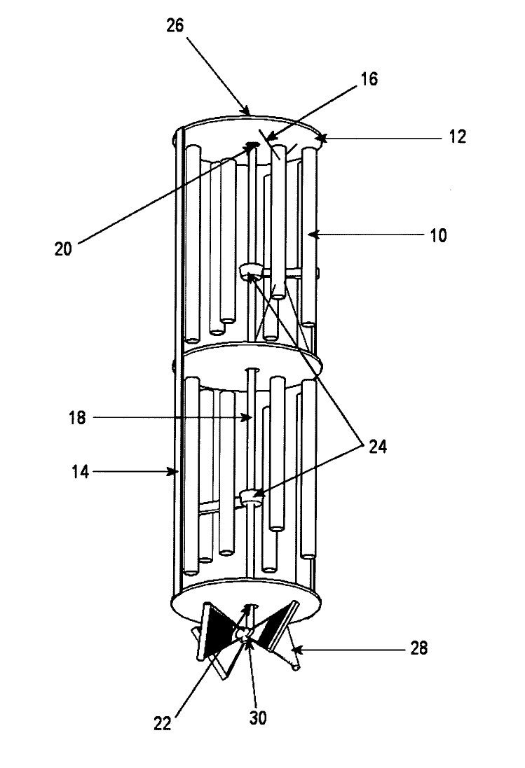

### BACKGROUND

### Field of the Invention

A wind powered chime for home enjoyment that plays notes in sequence to play songs, or multiple note chords.

### Description of the Related Art

Current wind chimes play random notes in an erratic order.

### SUMMARY

The Captive Wind Chime will play simple melodies by striking metal tubular chimes in order when the propeller is turned by the wind.

If outfitted with a second or third set of chimes multiple strikers will simultaneously play notes to form pleasing chords.

The metal chimes will be modular allowing users to change the tunes and notes.

### BRIEF DESCRIPTION OF THE DRAWINGS

The drawings show multiple angles of the basic design of a two tiered Captive Wind Chime.

The basic design would eliminate one set of chimes but still incorporate all other design aspects.

### DETAILED DESCRIPTION

Metal chimes [10] are suspended between two or more flat plates [12] of varying materials.

The plates [12] are supported solidly by flat or round “cage supports” [14] of varying materials.

Chimes [10] are suspended by natural or synthetic line [16] running through holes at both ends drilled at 22.4% of the length of the chime from the ends.

A central rod [18] runs from a bearing axel [20] under the top plate through any central plates, and through a one-way clutch [22] in the bottom plate.

The axel [20] allows the rod to turn freely.

The clutch [22] allows the rod to turn in only one direction.

The rod [18] supports one striker [24] per set of chimes.

The striker [24] hits the suspended chimes [10] in order and produces the musical notes.

The device is hung by a metal loop or support [26] which does not swivel, keeping the “cage” of the chime from spinning.

At the bottom of the central rod [18] are the blades [28] that catch the wind and cause the central rod [18] to spin and the strikers [24] to strike the chimes.

All blades [28] are angled in the same direction so that the wind will spin the rod [18] in only one direction.

The blades will pivot individually on a central axis joint [30] to keep the rod [18] from spinning too quickly in forceful wind.

The chime will be produced in a single tiered model which will only play single notes in order. (ie: Do, Re, Me, Fa, So, La, Te)

The chime will also be produced in a multi-tiered model (as shown in the drawing) with multiple layers of chimes and multiple strikers, this will allow synchronized striking of chimes, to produce multi-note chords.

1. A wind powered musical chime, comprising:
(a) hollow metal chimes which produce specific musical notes when struck, and
(b) flat round plates from which the chimes are suspended by cord, and
(c) a central turning axel which supports a striker,
(d) slanted blades which cause the axel to rotate in one direction only when blown by wind,
whereby wind causes musical notes to be played in a specific order producing pleasing melodies and chords.
